(19) United States
(12) Patent Application Publication
(10) Pub. No.: US 2019/0119098 A1
(43) Pub. Date: Apr. 25, 2019

(54) TRIMMED COMPONENT ASSEMBLY AND METHOD OF MAKING THE SAME

(71) Applicant: FORD GLOBAL TECHNOLOGIES, LLC, Dearborn, MI (US)

(72) Inventor: Shawn Tuffs, Wayne, MI (US)

(21) Appl. No.: 15/788,380

(22) Filed: Oct. 19, 2017

(51) Int. Cl. B68G 7/12

(52) U.S. Cl. CPC B68G 7/12; B60N 2/5875

(57) ABSTRACT

A trimmed component assembly has (a) a component body having a first side, a second side and a receiver in the first side, (b) an acircular retainer received and held in the receiver and (c) a trim material having a first portion captured in the receiver by the acircular retainer. A method of covering a component body with a trim material is also disclosed.

### TECHNICAL FIELD

This document relates generally to component assemblies and, more particularly, to a trimmed component assembly of a type that may be used, for example, in a motor vehicle.

### BACKGROUND

Trimmed component assemblies such as motor vehicle seat assemblies, center consoles and arm rests are well-known in the art. FIG. 1 illustrates one possible prior art trimmed component assembly A comprising a component body B covered with a trim material M. As illustrated, the trim material M is secured at one end by means of a Christmas tree C and a stiffener S. The trim material is then (a) folded back over the stiffener S and Christmas tree C concealing the stiffener and Christmas tree from view, (b) wrapped around the edge of E of the component body B and (c) fastened on the lower face F by an adhesive AD or other means.

As should be appreciated, such a prior art trimmed component assembly A requires two fastening components, the Christmas tree C and the stiffener S at one end and the trim material only loosely engages the component body B along the upper face UF of the component body (note space SP).

This document relates to a new and improved trimmed component assembly that relies on fewer parts to fasten the trim material at one end while also advantageously providing a flush and tight fit between the trim material and the component body along the upper face of the component body for a more aesthetically pleasing and seamless appearance. A new and improved method of covering a component body with a trim material is also disclosed.

### SUMMARY

In accordance with the purposes and benefits described herein, a new and improved trimmed component assembly is provided. That trimmed component assembly comprises (a) a component body have a first side, a second side and a receiver in the first side, (b) an acircular retainer received and held in the receiver and (c) a trim material having a first portion captured in the receiver by the acircular retainer.

The trim material may also include a second portion wrapped at least partially around the acircular retainer. That second portion may conceal the acircular retainer and the receiver. In addition, the trim material may include a third portion fastened to the second side of the component body.

The trimmed component assembly may also include an adhesive for fastening the third portion to the second side of the component body. In other possible embodiments, the trimmed component assembly includes a fastener for fastening the third portion to the second side of the component body.

In at least one of the many possible embodiments of the trimmed component assembly, the receiver is a three-sided channel. In at least one embodiment of many possible embodiments, the acircular retainer may have a polygonal cross section. In at least one embodiment of many possible embodiments, the acircular retainer may have a rectangular cross section. Advantageously, the acircular retainer resists twisting within the receiver so as to better capture and hold the first portion of the trim material within the receiver.

In accordance with an additional aspect, a method is provided of covering the component body with a trim material. That method comprises the steps of (a) positioning a first portion of the trim material over a receiver in a first side of the component body, (b) positioning the acircular retainer over the first portion of the trim material and (c) pressing the acircular retainer and the first portion into the receiver in order to capture the first portion in the receiver.

The method may include the additional step of wrapping a second portion of the trim material over the acircular retainer. Further, the method may include the step of stretching the trim material over the component body. Still further, the method may include the step of fastening a third portion of the trim material to a second side of the component body.

Still further, the method may include the step of fitting the trim material flush and tight against the component body. Further, the method may include fastening the third portion of the trim material to the second side of the component body with an adhesive. In other possible embodiments the method may include fastening the third portion of the trim material to the second side of the component body with one or more fasteners.

In the following description, there are shown and described several preferred embodiments of the trimmed component assembly and the related method of covering a component body with a trim material. As is should be realized, the trimmed component assembly and the related method are capable of other, different embodiments and their several details are capable of modification in various, obvious aspects all without departing from the trimmed component assembly and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the trimmed component assembly and related method and together with the description serve to explain certain principles thereof.

FIG. 1 is a view of a prior art trimmed component assembly wherein a first portion of the trim material is secured to the component body by means of a cooperating Christmas tree and stiffener.

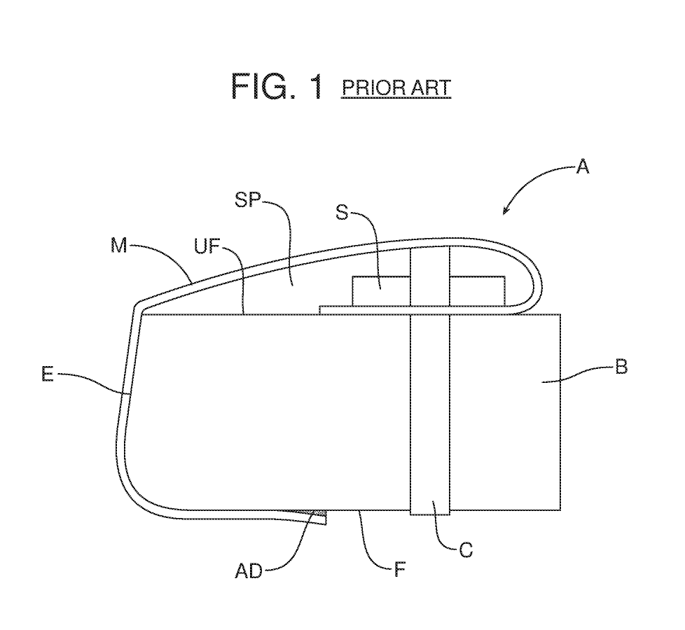

FIGS. 2a-2f are a series of schematic views illustrating the new and improved method of covering a component body with a trim material.

FIG. 2a illustrates the step of positioning a first portion of the trim material over a receiver in a first side of the component body.

FIG. 2b illustrates the steps of positioning an acircular retainer over the first portion of the trim material and pressing the acircular retainer and the first portion of the trim material into the receiver in order to capture the first portion in the receiver.

FIG. 2c illustrates the retainer fully seated in the receiver capturing the first portion of the trim material in the receiver.

FIGS. 2d and 2e illustrate the step of wrapping a second portion of the trim material over the acircular retainer as well as the step of stretching the trim material over the component body.

FIG. 2f illustrates the additional step of fastening a third portion of the trim material to a second side of the component body in order to produce the new and improved trimmed component assembly.

Reference will now be made in detail to the present preferred embodiments of the trimmed component assembly and related method of covering a component body with a trim material, examples of which are illustrated in the accompanying drawing figures.

### DETAILED DESCRIPTION

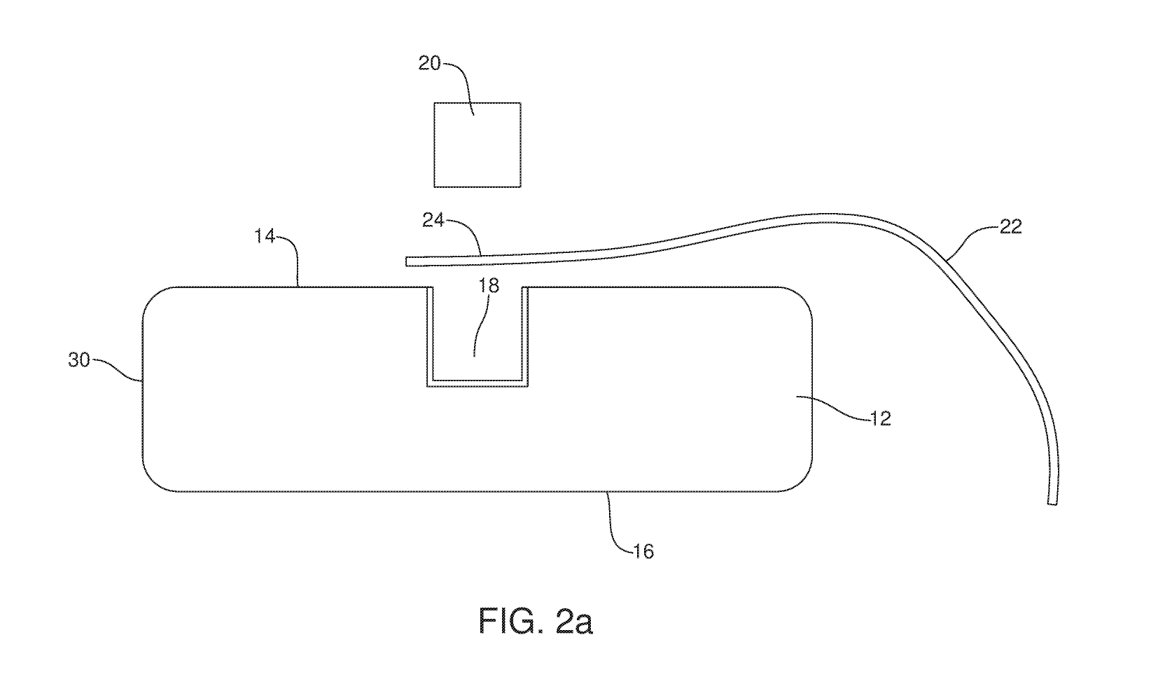

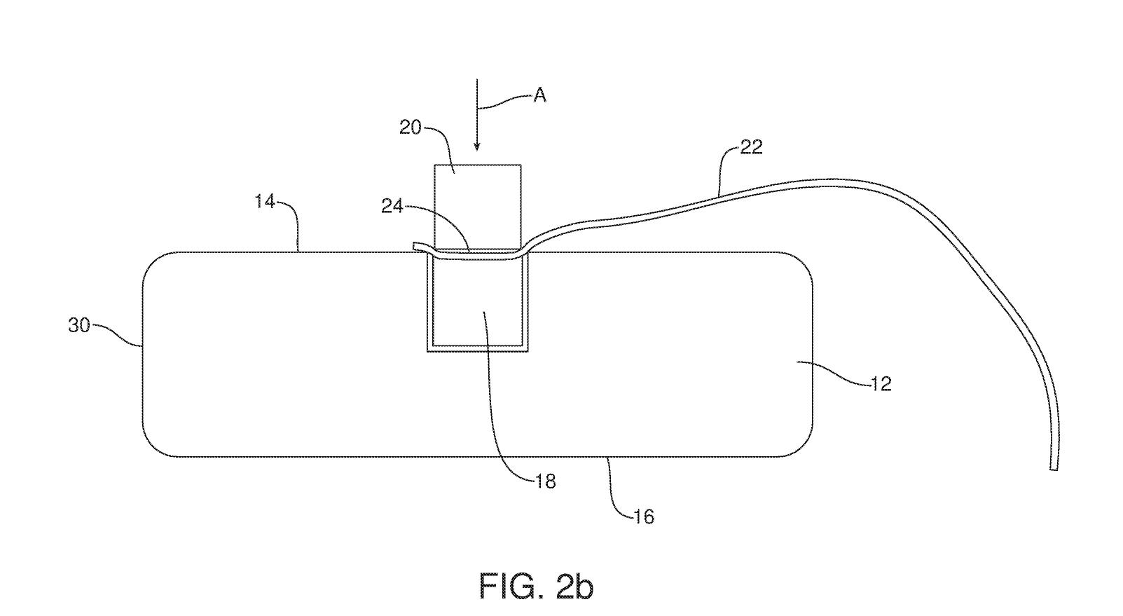

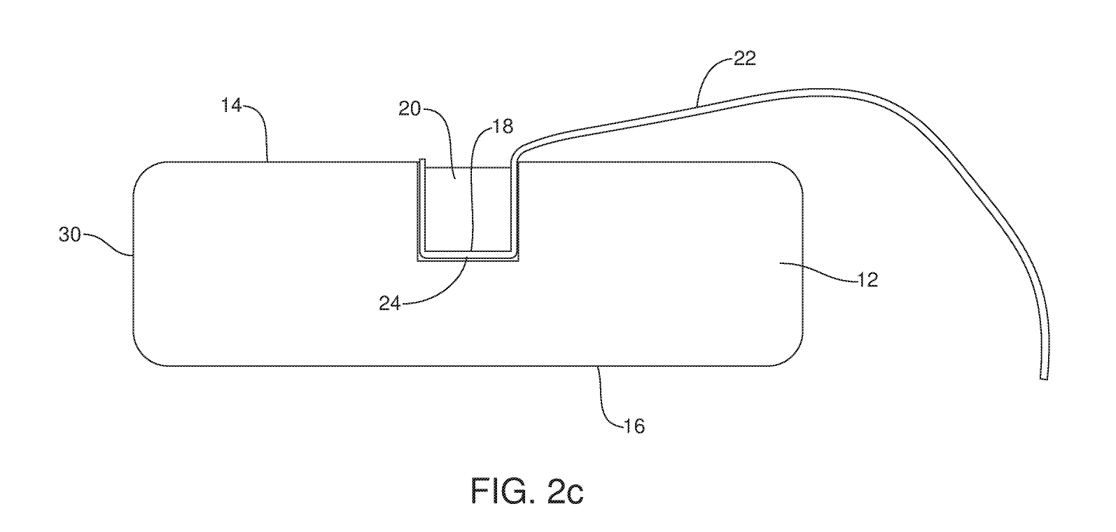

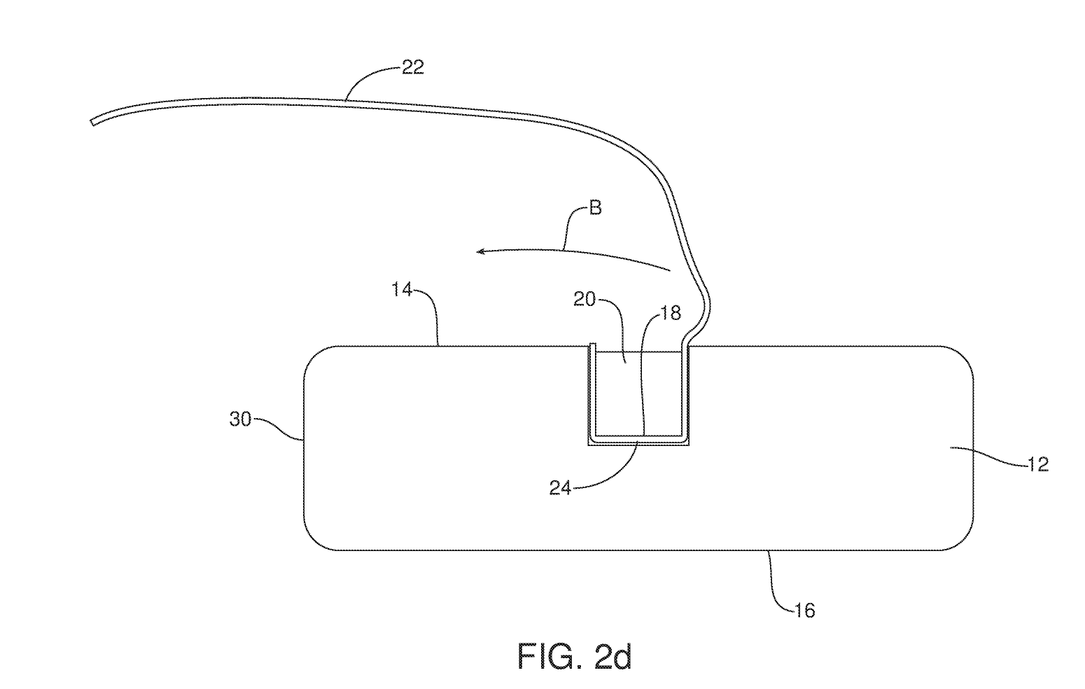

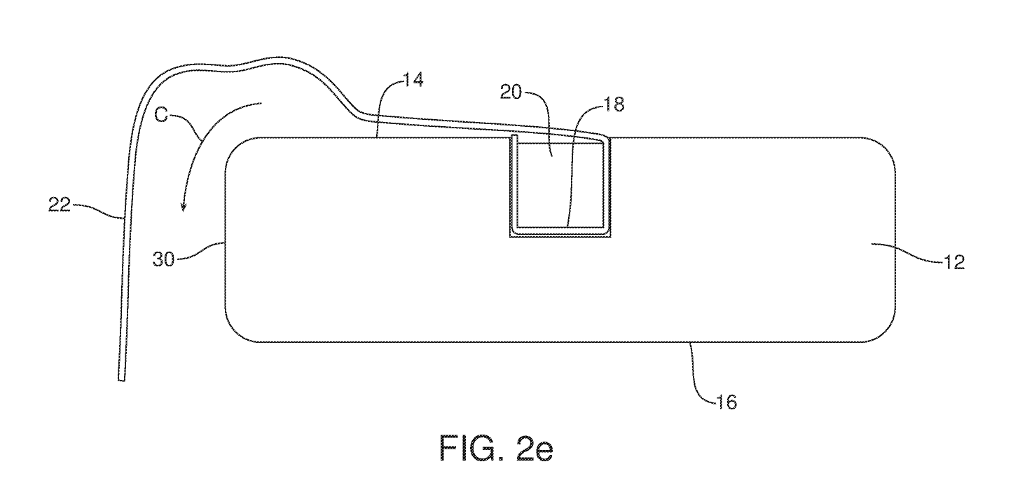

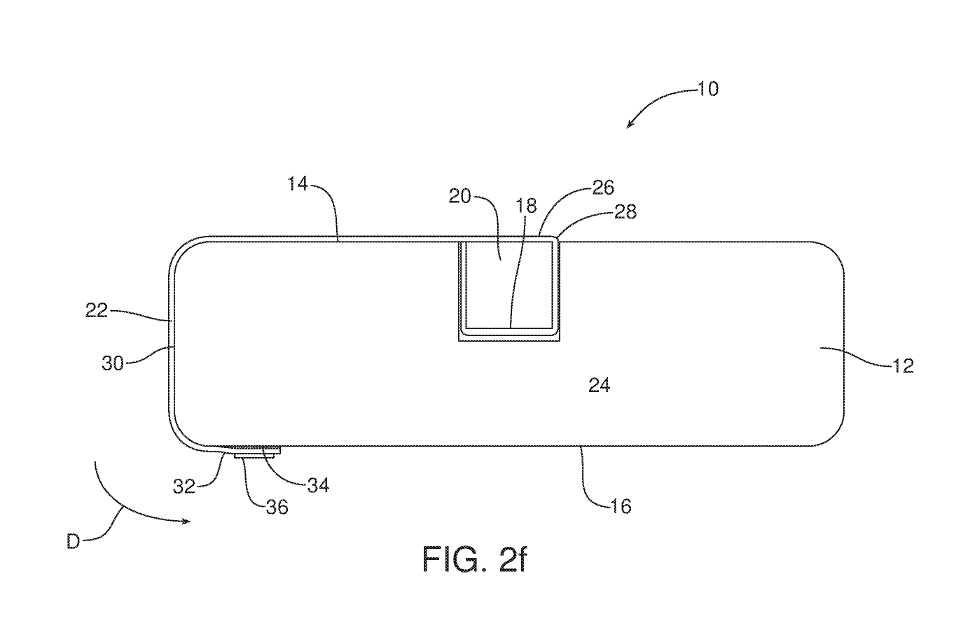

Reference is now made to FIGS. 2a-2f which schematically illustrate, step-by-step, the new and improved method of covering a component body with a trim material to produce the new and improved trimmed component assembly 10 illustrated in FIG. 2f.

As illustrated in FIG. 2f, the trimmed component assembly 10 includes a component body 12 having a first side 14, a second side 16, and a receiver 18 in the first side. In the illustrated embodiment, the receiver 18 comprises a three-sided channel. An acircular retainer 20 is received and held in the receiver 18. A trim material 22 includes a first portion 24 captured in the receiver 18 by the acircular retainer 20.

More specifically, the acircular retainer 20 may have a polygonal cross section and, more particularly, a rectangular cross section as illustrated in FIG. 2f. When the acircular retainer 20 and the first portion 24 of the trim material 22 are press fit into the receiver 18, an interference fit is provided securely holding the first portion of the trim material captured between the acircular retainer and walls of the receiver. Significantly, the acircular cross section of the retainer 20 functions to resist any rotation of the acircular retainer within the receiver 18 thereby better retaining the trim material in the desired position.

As further illustrated in FIG. 2f, a second portion 26 of the trim material 22 is wrapped at least partially around the acircular retainer 20. That second portion 26 conceals the acircular retainer 20 and the receiver 18 while also providing a crisp, trim edge at 28.

As further illustrated in FIG. 2f, the trim material 22 is stretched around the edge 30 of the component body 12 with a third portion 32 of the trim material 22 being fastened to the second side 16 of the component body by an adhesive 34 and/or a fastener 36. As should be appreciated from reviewing FIG. 2f, the trim material 22 fits tight and flush over the first side 14 and edge 30 of the component body 12 so as to provide an aesthetically pleasing appearance.

The new and improved method of covering a component body 12 with a trim material 22 will now be described in detail with reference to FIGS. 2a-2f.

As illustrated in FIG. 2a, that method includes the step of positioning the first portion 24 of the trim material 22 over the receiver 18 provided in the first side 14 of the component body 12.

As should be appreciated from reviewing FIGS. 2a and 2b, that method also includes the step of positioning the acircular retainer 20 over the first portion 24 of the trim material 22. As illustrated in FIGS. 2b and 2c, the method then includes the step of pressing the acircular retainer 20 and the first portion 24 of the trim material 22 downwardly in the direction of action arrow A into the receiver 18 in order to capture the first portion of the trim material in the receiver between the acircular retainer and the walls of the receiver. Please note FIG. 2c showing the acircular retainer 20 fully seated within the receiver 18 with the first portion 24 of the trim material 22 captured in the receiver between the acircular retainer and the receiver walls. Also note, how the acircular retainer 20 is sized and shaped to effectively fill the top of the receiver 18 from sidewall to sidewall.

Next, the method includes the step of wrapping the second portion 26 of the trim material 22 over the top of the acircular retainer 20. This is done in conjunction with stretching the trim material 22 over the component body 12 and, more particularly, the upper face or first side 14 of the component body and around the edge 30 to the lower face or second side 16 of the component body as illustrated by action arrows B, C and D in FIGS. 2d-2f. Thus, it should be appreciated that method also includes the step of fitting the trim material 22 flush and tight against the component body 12. Significantly, the fact that the retainer 20 effectively fills the receiver 18 to approximately the top of the sidewalls better ensures a smooth, tight surface line with no valleys or hollows.

This is then followed by the step of fastening the third portion 32 of the trim material 22 to the second side 16 of the component body 12. This may be done by providing an adhesive 34 between the third portion 32 of the trim material 22 and the second side 16 of the component body 12, by providing a fastener 36 such as a Christmas tree or the like that secures the third portion to the second face of the component body or by using both the adhesive and the fastener. See FIG. 2f.

In summary, the new and improved method of covering a component body 12 with a trim material 22 and the resulting new and improved trimmed component assembly 10 are characterized by a number of benefits and advantages. The method is simple, efficient and inexpensive. By utilizing the acircular retainer 20 and receiver 18 instead of a Christmas tree and stiffener to secure the first portion 24 of the trim material 22 to the first side 14 of the component body 12, the number of component parts is reduced.

Advantageously, by utilizing an acircular retainer 20 relative rotation of the retainer in the receiver 18 is resisted and it is possible to make a tighter, flusher fit between the trim material 22 and the component body 12. Further, the retainer 20 has a shape and volume that effectively fills the receiver 18, when seated therein and capturing the first portion 24 of the trim material 22 in position, so as to effectively eliminate any unsightly valleys or creases in the appearance of the overlying trim material. This allows for a crisp trim edge 28 and an overall more aesthetically pleasing appearance for the trimmed component assembly 10.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A trimmed component assembly, comprising:
a component body having a first side, a second side and a receiver in said first side;
an acircular retainer received and held in said receiver; and
a trim material having a first portion captured in said receiver by said acircular retainer.

2. The trimmed component assembly of claim 1 wherein said trim material includes a second portion wrapped at least partially around said acircular retainer.

3. The trimmed component assembly of claim 2, wherein said second portion conceals said acircular retainer and said receiver.

4. The trimmed component assembly of claim 3, wherein said trim material includes a third portion fastened to said second side of said component body.

5. The trimmed component assembly of claim 4, further including an adhesive fastening said third portion to said second side of said component body.

6. The trimmed component assembly of claim 4, further including a fastener fastening said third portion to said second side of said component body.

7. The trimmed component assembly of claim 1, wherein said receiver is a three-sided channel.

8. The trimmed component assembly of claim 7, wherein said acircular retainer has a polygonal cross section.

9. The trimmed component assembly of claim 7, wherein said acircular retainer has a rectangular cross section.

10. A method of covering a component body with a trim material, comprising:
positioning a first portion of said trim material over a receiver in a first side of said component body; and
positioning an acircular retainer over said first portion of said trim material and pressing said acircular retainer and said first portion into said receiver in order to capture said first portion in said receiver.

11. A method of claim 10, including wrapping a second portion of said trim material over said acircular retainer.

12. The method of claim 11, including stretching said trim material over said component body.

13. The method of claim 12, including fastening a third portion of said trim material to a second side of said component body.

14. The method of claim 13, including fitting said trim material flush against said component body.

15. The method of claim 14, including fastening said third portion of said trim material to said second side of said component body with an adhesive.

16. The method of claim 14, including fastening said third portion of said trim material to said second side of said component body with a fastener.
